(19) United States
(12) Patent Application Publication
(10) Pub. No.: US 2026/0284823 A1
(43) Pub. Date: Sep. 24, 2026

(54) CLEANING TAPE

(71) Applicant: Sony Group Corporation, Tokyo (JP)

(72) Inventors: Kazuya HASHIMOTO, Tokyo (JP); Takanobu IWAMA, Tokyo (JP); Masaki SUGAWARA, Tokyo (JP); Minoru YAMAGA, Tokyo (JP); Jun TAKAHASHI, Tokyo (JP); Kohei OTODUKI, Tokyo (JP); Syogo YOSHIKAWA, Tokyo (JP)

(21) Appl. No.: 19/478,185

(22) PCT Filed: May 9, 2024
(86) PCT No.: PCT/JP2024/017205

§ 371 Date: Oct. 23, 2025

(30) Foreign Application Priority Data
May 24, 2023 (JP) 2023-085768

(51) Int. Cl. B24B 27/033

(52) U.S. Cl. CPC B24B 27/033

(57) ABSTRACT

An object of the present technology is to provide a cleaning tape with a high cleaning power that can be used for next-generation media having a small bit size.

The present technology provides a cleaning tape including a magnetic layer and an underlayer in this order, in which an average thickness of the underlayer is 1.60 μm or more, a surface roughness Rab of a surface of the magnetic layer is 2.9 nm or less, and an abrasivity of 50 reciprocations with respect to an AlFeSil prism is 65 μm or less, and an abrasivity of 50 reciprocations to 100 reciprocations with respect to the AlFeSil prism is 25 μm or more. The magnetic layer can contain a magnetic powder. The magnetic powder can be a barium ferrite magnetic powder.

### TECHNICAL FIELD

The present technology relates to a cleaning tape.

### BACKGROUND ART

For example, with the advancement of IoT, big data, artificial intelligence, and the like, the amount of data collected and stored is increasing significantly. In many cases, magnetic recording media are used to record a large amount of data.

Data is recorded and reproduced in a magnetic recording and reproducing apparatus using such a magnetic recording medium while a magnetic head of the magnetic recording and reproducing apparatus and the magnetic recording medium are brought into contact with each other. At this time, when the scraping powder of the magnetic recording medium adheres to the surface of the magnetic head (this is so-called “dusting”), the reproduction output decreases, and moreover, the reproduction output cannot be obtained at all. For this reason, various techniques have been proposed so far for a cleaning tape for removing the scraping powder adhering to the surface of the magnetic head. For example, Patent Document 1 below discloses a coating-type cleaning tape obtained by applying a magnetic coating material containing a ferromagnetic powder and a binder onto a non-magnetic support. Furthermore, Patent Document 2 below discloses a vapor-deposition-type cleaning tape including a magnetic layer including at least a metal magnetic thin film on a non-magnetic support, in which the metal magnetic thin film includes an alloy in which a ratio of Co is 60 to 100 atom %, a ratio of Ni is 0 to 40 atom %, and a ratio of other elements is 5 atom % or less.

### CITATION LIST

### Patent Document

Patent Document 1: Japanese Patent Application Laid-Open No. 2000-57541
Patent Document 2: Japanese Patent Application Laid-Open No. H8-315327

### SUMMARY OF THE INVENTION

### Problems to be Solved by the Invention

A main object of the present technology is to provide a cleaning tape with a high cleaning power that can be used for next-generation media having a small bit size.

### Solutions to Problems

The present technology provides a cleaning tape including: a magnetic layer; and an underlayer in this order, in which
an average thickness of the underlayer is 1.60 μm or more,
a surface roughness Rab of a surface of the magnetic layer is 2.9 nm or less, and
an abrasivity of 50 reciprocations with respect to an AlFeSil prism is 65 μm or less, and an abrasivity of 50 reciprocations to 100 reciprocations with respect to the AlFeSil prism is 25 μm or more.

The magnetic layer can contain a magnetic powder.

The magnetic powder can contain barium ferrite.

The average thickness (average total thickness) can be 9.2 μm or less.

The average thickness of the underlayer can be 1.85 μm or less.

When a standard cleaning tape is slid while being brought into contact with a surface of a polishing tape for a magnetic medium, and then a region of a part of the surface, which is in contact with the standard cleaning tape, of the polishing tape for a magnetic medium is imaged, among pixels constituting a captured image, a ratio (dusting rate) of a proportion of a pixel in which powder adhering to the polishing tape for a magnetic medium due to dusting from the cleaning tape to be inspected is imaged to a proportion of a pixel in which powder adhering to the polishing tape for a magnetic medium due to dusting from the standard cleaning tape is imaged can be less than 1.0.

An average particle volume of the barium ferrite magnetic powder can be 500 nm³ to 2000 nm³.

The cleaning tape can further contain abrasive particles in the magnetic layer.

The abrasive particles can be alumina particles.

An average particle size of the alumina particles can be 20 nm to 80 nm.

An electric resistance value of the surface of the magnetic layer of the cleaning tape can be 1×10³ Ω/sq to 5×10¹⁰ Ω/sq.

The average thickness of the underlayer can be 1.67 μm or more.

The cleaning tape according to the present technology can include a magnetic layer, an underlayer, a base layer, and a back layer in this order.

The average thickness (average total thickness) can be 8.80 μm or more.

The present technology also provides the cleaning tape which is a cleaning tape for a magnetic recording system.

### BRIEF DESCRIPTION OF DRAWINGS

FIG. 1 is a cross-sectional view illustrating a configuration of a cleaning tape according to a first embodiment.

FIG. 2 is a schematic view illustrating a configuration of a dedicated jig for abrasivity measurement.

FIG. 3 is a schematic view illustrating an abrasivity bar.

FIG. 4 is a schematic view illustrating a wear amount (scraping amount) of the abrasivity bar.

FIG. 5 is an exploded perspective view illustrating an example of a configuration of a cleaning tape cartridge.

FIG. 6 is a view illustrating an example of a shape of magnetic powder particles.

FIG. 7 shows an example of a TEM photograph of a sample cross section.

FIG. 8 shows another example of a TEM photograph of a sample cross section.

FIG. 9 is a cross-sectional view illustrating a configuration of a rewinding machine.

### MODE FOR CARRYING OUT THE INVENTION

Hereinafter, preferred modes for carrying out the present technology will be described. Note that embodiments described below illustrate representative embodiments of the present technology, and the scope of the present technology is not limited only to these embodiments.

The present technology will be described in the following order.
1. Description of present technology
2. Embodiments of present technology
(1) Configuration of cleaning tape
(2) Description of each layer
(3) Physical properties and structure
(4) Method for manufacturing cleaning tape
(5) One embodiment of cleaning tape cartridge
3. Examples

In the present specification, in a case where a measurement environment is not particularly described with respect to the description of a measurement method, the measurement is performed under an environment of 25° C.±2° C. and 50% RH±5% RH.

### 1. DESCRIPTION OF PRESENT TECHNOLOGY

In next-generation media, the bit size is reduced in order to achieve higher density recording. When the bit size decreases, the recording and reproducing apparatus stops due to an error even in the case of small dusting in the magnetic head. In the conventional cleaning tape, small dusting in the magnetic head cannot be removed, and occurrence of an error cannot be suppressed.

The present inventors have found that by adjusting an appropriate polishing force while the surface of the cleaning tape is smooth, small dusting occurring from the cleaning tape can be suppressed, and an adhering matter adhering to the magnetic head can be removed without damaging the magnetic head. Furthermore, the present inventors have found that small dusting can be suppressed by smoothing the surface of the cleaning tape, and occurrence of head scratches can be suppressed while removing the adhering matter by making the polishing force appropriate. Moreover, the present inventors have found that, for example, by using a barium ferrite magnetic powder having a small particle diameter and alumina particles having a small diameter, the surface of the cleaning tape can be made smooth, and the polishing force can be maintained by optimizing process conditions (such as lowering the calendering treatment temperature).

That is, the cleaning tape according to the present technology includes a magnetic layer and an underlayer in this order. Moreover, the cleaning tape according to the present technology can include a magnetic layer, an underlayer, a base layer, and a back layer in this order.

The cleaning tape according to the present technology can preferably be an elongated cleaning tape.

In the cleaning tape according to the present technology, from the viewpoint of preventing that the magnetic layer is crushed to reduce the abrasivity when the magnetic head of the magnetic recording and reproducing apparatus and the cleaning tape come into contact with each other, and the adhering matter adhering to the magnetic head cannot be removed, the average thickness of the underlayer can be 1.60 μm or more, preferably 1.65 μm or more, more preferably 1.67 μm or more, and still more preferably 1.70 μm or more. Furthermore, from the viewpoint of preventing the occurrence of damage to the magnetic head due to an increase in abrasivity, the average thickness of the underlayer can be 1.85 μm or less, preferably 1.80 μm or less, more preferably 1.78 μm or less, and still more preferably 1.75 μm or less. A method for measuring the average thickness of the underlayer will be described in the following 2. (3).

From the viewpoint of adjusting an appropriate abrasivity by the average thickness of the underlayer, an average thickness (average total thickness) t_{T} of the cleaning tape according to the present technology can be, for example, preferably 9.20 μm or less, more preferably 9.15 μm or less, further preferably 9.10 μm or less, and still more preferably 9.00 μm or less. The average thickness (average total thickness) t_{T} of the cleaning tape can be, for example, preferably 8.60 μm or more, more preferably 8.70 μm or more, further preferably 8.75 μm or more, and still more preferably 8.80 μm or more. A method for measuring the average thickness (average total thickness) t_{T} of the cleaning tape will be described in the following 2. (3).

In the cleaning tape according to the present technology, from the viewpoint of preventing that the abrasivity is reduced when the magnetic head and the cleaning tape come into contact with each other, and the adhering matter adhering to the magnetic head cannot be removed, the average thickness of the magnetic layer can be preferably 0.060 μm or more, more preferably 0.063 μm or more, further preferably 0.066 μm or more, and still more preferably 0.069 μm or more. Furthermore, from the viewpoint of preventing the occurrence of damage to the magnetic head due to an increase in abrasivity, the average thickness of the magnetic layer can be preferably 0.080 μm or less, more preferably 0.077 μm or less, further preferably 0.074 μm or less, and still more preferably 0.071 μm or less. A method for measuring the average thickness of the magnetic layer will be described in the following 2. (3).

The average thickness of the base layer of the cleaning tape according to the present technology can be preferably 6.3 μm or more, more preferably 6.4 μm or more, and further preferably 6.5 μm or more, and can be preferably 6.8 μm or less, more preferably 6.7 μm or less, and further preferably 6.6 μm or less. A method for measuring the average thickness of the base layer will be described in the following 2. (3).

The average thickness of the back layer of the cleaning tape according to the present technology can be preferably 0.30 μm or more, more preferably 0.35 μm or more, further preferably 0.40 μm or more, and still more preferably 0.45 μm or more, and can be preferably 0.65 μm or less, more preferably 0.60 μm or less, further preferably 0.55 μm or less, and still more preferably 0.50 μm or less. A method for measuring the average thickness of the back layer will be described in the following 2. (3).

In the cleaning tape according to the present technology, from the viewpoint of obtaining a favorable cleaning power for a magnetic head, the surface roughness Rab of the surface of the magnetic layer can be 2.9 nm or less, preferably 2.8 nm or less, more preferably 2.7 nm or less, and further preferably 2.6 nm or less. Furthermore, the surface roughness Rab of the surface of the magnetic layer can be preferably 2.0 nm or more. A method for measuring the surface roughness Rab of the surface of the magnetic layer will be described in the following 2. (3).

In the cleaning tape according to the present technology, from the viewpoint of preventing the abrasion of the magnetic head from proceeding due to the too high polishing force to cause the destruction of the magnetic head, the abrasivity of 50 reciprocations with respect to the AlFeSil prism can be 65 μm or less, preferably 60 μm or less, more preferably 55 μm or less, further preferably 50 μm or less, and still more preferably 47 μm or less. Furthermore, in the cleaning tape according to the present technology, from the viewpoint of improving the polishing force and removing the adhering matter adhering to the magnetic head, the abrasivity of 50 reciprocations to 100 reciprocations with respect to the AlFeSil prism can be 25 μm or more and preferably 26 μm or more. A method for measuring the abrasivity with respect to the AlFeSil prism will be described in the following 2. (3).

The magnetic layer of the cleaning tape according to the present technology can contain a magnetic powder. The magnetic powder can preferably include a barium ferrite magnetic powder. The average particle volume of the barium ferrite magnetic powder can be preferably 2000 nm³ or less, more preferably 1800 nm³ or less, and further preferably 1600 nm³ or less. When the average particle volume is in the above numerical range, the smooth surface property of the cleaning tape can be achieved. Furthermore, the average particle volume of the barium ferrite magnetic powder can be preferably 500 nm³ or more, more preferably 800 nm³ or more, further preferably 1000 nm³ or more, and still more preferably 1200 nm³ or more. A method for measuring the average particle volume of the barium ferrite magnetic powder will be described in the following 2. (3).

In the cleaning tape according to the present technology, from the viewpoint of preventing the destruction of the magnetic head due to the influence of overcurrent or static electricity, the range of the electric resistance value on the surface of the magnetic layer can be preferably 1×10³ Ω/sq to 5×10¹⁰ Ω/sq.

### 2. EMBODIMENTS OF PRESENT TECHNOLOGY

### (1) Configuration of Cleaning Tape

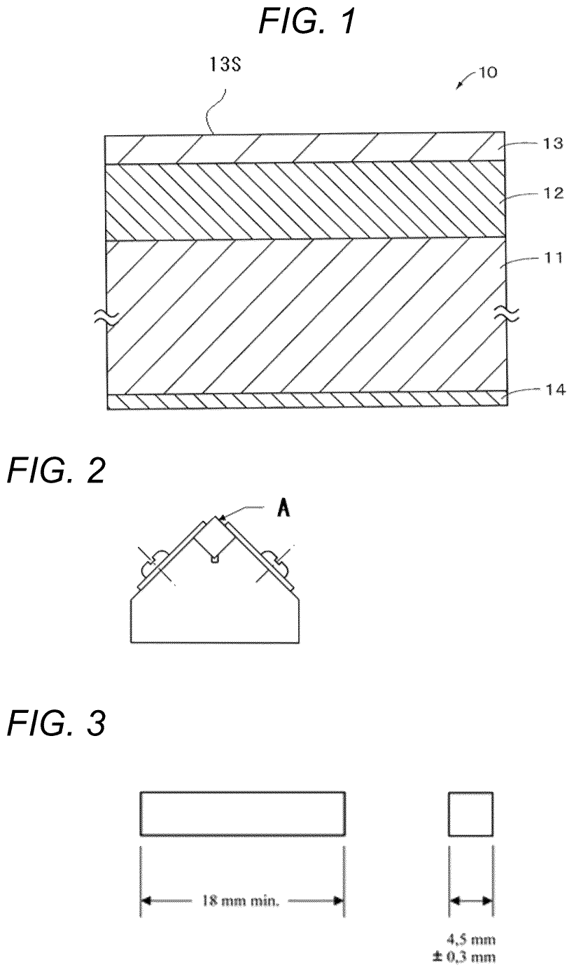

First, a configuration of a cleaning tape 10 according to an embodiment of the present technology will be described with reference to FIG. 1. As illustrated in FIG. 1, the cleaning tape 10 includes an elongated base layer (also referred to as a substrate) 11, an underlayer 12 provided on one of the main surfaces of the base layer 11, a magnetic layer 13 provided on the underlayer 12, and a back layer 14 provided on the other main surface of the base layer 11. Hereinafter, of both the main surfaces of the cleaning tape 10, a surface where the magnetic layer 13 is provided is referred to as a magnetic surface, and a surface opposite to the magnetic surface (surface where the back layer 14 is provided) is referred to as a back surface.

The cleaning tape 10 has an elongated shape and is caused to travel in the longitudinal direction during recording and reproduction.

### (2) Description of Each Layer

### (Base Layer)

The base layer 11 can act as a support of the cleaning tape 10, and can be, for example, an elongated, flexible, non-magnetic substrate, particularly, a non-magnetic film. The base layer 11 can contain, for example, at least one of a polyester-based resin, a polyolefin-based resin, a cellulose derivative, a vinyl-based resin, an aromatic polyether ketone resin, or other polymer resins. In a case where the base layer 11 contains two or more of the above-described materials, the two or more materials can be mixed, copolymerized, or layered.

The polyester-based resin can be, for example, one or a mixture of two or more of polyethylene terephthalate (PET), polyethylene naphthalate (PEN), polybutylene terephthalate (PBT), polybutylene naphthalate (PBN), polycyclohexylenedimethylene terephthalate (PCT), polyethylene-p-oxybenzoate (PEB), and polyethylene bisphenoxycarboxylate. According to a preferred embodiment of the present technology, the base layer 11 can include PET or PEN.

The polyolefin-based resin can be, for example, one or a mixture of two or more of polyethylene (PE) and polypropylene (PP).

The cellulose derivative can be, for example, one or a mixture of two or more of cellulose diacetate, cellulose triacetate, cellulose acetate butyrate (CAB), and cellulose acetate propionate (CAP).

The vinyl-based resin can be, for example, one or a mixture of two or more of polyvinyl chloride (PVC) and polyvinylidene chloride (PVDC).

The aromatic polyether ketone resin can be, for example, one or a mixture of two or more of polyether ketone (PEK), polyether ether ketone (PEEK), polyether ketone ketone (PEKK), and polyether ether ketone ketone (PEEKK). According to a preferred embodiment of the present technology, the base layer 11 can include PEEK.

The other polymer resins can be, for example, one or a mixture of two or more of a polyamide, nylon (PA), an aromatic polyamide, aramid (aromatic PA), a polyimide (PI), an aromatic polyimide (aromatic PI), a polyamideimide (PAI), an aromatic polyamideimide (aromatic PAI), polybenzoxazole such as Zylon (registered trademark) (PBO), a polyether, a polyether ester, polyether sulfone (PES), polyether imide (PEI), polysulfone (PSF), polyphenylene sulfide (PPS), polycarbonate (PC), polyarylate (PAR), and a polyurethane (PU).

### (Magnetic Layer)

The magnetic layer 13 can contain a magnetic powder. The magnetic powder can preferably contain a barium ferrite magnetic powder. The magnetic layer 13 can contain abrasive particles and conductive particles in addition to the barium ferrite magnetic powder. Furthermore, the magnetic layer 13 can further contain a binding agent and an additive in addition to the above-described components.

### (Magnetic Powder)

Examples of the magnetic particles constituting the magnetic powder contained in the magnetic layer 13 include, but are not limited to, hexagonal ferrite, barium ferrite (BaFe), Co ferrite, and strontium ferrite. The magnetic powder can be one of these, or can be a combination of two or more of these. Particularly preferably, the magnetic powder can include a barium ferrite magnetic powder, a cobalt ferrite magnetic powder, or a strontium ferrite magnetic powder. These magnetic particles can be appropriately selected by those skilled in the art on the basis of factors such as the method for manufacturing the magnetic layer 13.

The average particle size (average maximum particle size) D of the magnetic powder can be preferably 22 nm or less, more preferably 8 nm or more and 22 nm or less, and still more preferably 10 nm or more and 20 nm or less.

The average particle size D of the magnetic powder described above is determined as follows. First, the magnetic recording medium 10 to be measured is thin-sectioned using the focused ion beam (FIB) method or the like to prepare a thin piece, and a cross section of the thin piece is observed with a TEM. Next, 500 ε-iron oxide particles are randomly selected from the imaged TEM photograph, the maximum particle size dₘₐₓ of each particle is measured, and the particle size distribution of the maximum particle size dₘₐₓ of the magnetic powder is determined. Here, the “maximum particle size dₘₐₓ” refers to a so-called maximum Feret's diameter, and specifically refers to the largest distance between two parallel lines drawn from all angles to come into contact with the contour of the s-iron oxide particle. Thereafter, the median diameter (50% diameter, D50) is determined from the determined particle size distribution of the maximum particle size dₘₐₓ, and is taken as the average particle size (average maximum particle size) D of the magnetic powder.

The shape of the magnetic powder is preferably at least one of a plate shape or a square shape. The shape of the magnetic powder depends on the crystal structure of the magnetic particles. Examples of the magnetic powder having a plate shape include BaFe and strontium ferrite having a hexagonal plate shape. Examples of the magnetic powder having a square shape include cobalt ferrite having a cubic shape.

According to another preferred embodiment of the present technology, the magnetic powder can include a barium ferrite (BaFe) magnetic powder. A barium ferrite magnetic powder contains iron oxide magnetic particles including barium ferrite as a main phase (hereinafter, referred to as “barium ferrite particles”). The barium ferrite magnetic powder can realize a smooth surface property of the cleaning tape. From such a viewpoint, a barium ferrite magnetic powder is preferable as the magnetic powder.

The average particle size of the barium ferrite magnetic powder can be preferably 50 nm or less, more preferably 10 nm or more and 40 nm or less, and still more preferably 12 nm or more and 25 nm or less.

According to still another preferred embodiment of the present technology, the magnetic powder can be a cobalt ferrite magnetic powder. The cobalt ferrite magnetic powder contains iron oxide magnetic particles including cobalt ferrite as a main phase (hereinafter, referred to as “cobalt ferrite magnetic particles”). The cobalt ferrite magnetic particles preferably have uniaxial crystal anisotropy. The cobalt ferrite magnetic particles have, for example, a cubic shape or a nearly cubic shape. Cobalt ferrite is cobalt ferrite containing Co. The cobalt ferrite can further contain one or more selected from the group consisting of Ni, Mn, Al, Cu, and Zn, in addition to Co.

The cobalt ferrite has, for example, an average composition represented by the following formula (1):

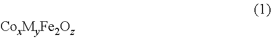

where, in the formula (1), M is, for example, one or more metals selected from the group consisting of Ni, Mn, Al, Cu, and Zn; x is a value within a range of 0.4≤x≤1.0; y is a value within a range of 0≤y≤0.3; provided that, x and y satisfy a relationship of (x+y)≤1.0; z is a value within a range of 3≤z≤4; and a part of Fe can be substituted with another metal element.

The average particle size of the cobalt ferrite magnetic powder can be preferably 25 nm or less, and more preferably 23 nm or less.

According to still another preferred embodiment of the present technology, the magnetic powder can include a powder of nanoparticles containing hexagonal ferrite (hereinafter, also referred to as “hexagonal ferrite particles”). The hexagonal ferrite particles have, for example, a hexagonal plate shape or a substantially hexagonal plate shape. The hexagonal ferrite can preferably contain at least one of Ba, Sr, Pb, or Ca, and can more preferably contain at least one of Ba or Sr. Specifically, the hexagonal ferrite can be, for example, barium ferrite or strontium ferrite. The barium ferrite can further contain at least one of Sr, Pb, or Ca, in addition to Ba. The strontium ferrite can further contain at least one of Ba, Pb, or Ca, in addition to Sr.

More specifically, the hexagonal ferrite can have an average composition represented by general formula MFe₁₂O₁₉. Here, M is, for example, at least one metal of Ba, Sr, Pb, or Ca, and preferably at least one metal of Ba or Sr. M can be a combination of Ba and one or more metals selected from the group consisting of Sr, Pb, and Ca. Furthermore, M can be a combination of Sr and one or more metals selected from the group consisting of Ba, Pb, and Ca. A part of Fe in the above-described general formula can be substituted with another metal element.

In a case where the magnetic powder contains powder of hexagonal ferrite particles, the average particle size of the magnetic powder can be preferably 50 nm or less, more preferably 10 nm or more and 40 nm or less, and still more preferably 15 nm or more and 30 nm or less.

### (Abrasive Particles)

The abrasive particles can be preferably inorganic particles. Examples of such abrasive particles include α-alumina with a gelatinization rate of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by dehydrating and annealing magnetic iron oxide raw material, those obtained by performing surface treatment thereon with aluminum and/or silica as necessary, and diamond powder. As the abrasive particles, alumina particles such as α-alumina, β-alumina, and γ-alumina, and silicon carbide are preferably used. These abrasive particles can have any shape such as an acicular shape, a spherical shape, and a dice shape, but those having some corners in their shapes are preferable because they have a high abrasivity. The average particle size of the abrasive particles can be preferably 20 nm to 80 nm, more preferably 25 nm to 75 nm, further preferably 30 nm to 70 nm, and still more preferably 35 nm to 65 nm. Furthermore, in a case where the abrasive particles are alumina particles, the average particle size of the alumina particles can be preferably 20 nm to 80 nm, more preferably 25 nm to 75 nm, further preferably 30 nm to 70 nm, and still more preferably 35 nm to 65 nm.

### (Conductive Particles)

As the conductive particles, fine particles containing carbon as a main component can be used, and for example, carbon particles can be preferably used, and examples of such carbon particles include carbon black. As the carbon black, for example, Asahi #15, #15HS manufactured by Asahi Carbon Co., Ltd., and the like can be used. Furthermore, hybrid carbon can be used in which carbon is attached to a silica particle surface. The average particle size of the conductive particles can be preferably 30 nm to 90 nm, more preferably 40 nm to 80 nm, further preferably 45 nm to 75 nm, and still more preferably 50 nm to 70 nm.

### (Binding Agent)

As the binding agent, a resin with a crosslinked structure applied to polyurethane-based resin, vinyl chloride-based resin, or the like is preferable. However, the binding agent is not limited to such a resin, and other resins can be appropriately blended according to physical properties and the like required for the cleaning tape 10. The resin to be blended is not particularly limited as long as it is commonly used in the coating-type cleaning tape 10.

Examples of the binding agent include polyvinyl chloride, polyvinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, or nitrocellulose), a styrene-butadiene copolymer, a polyester resin, an amino resin, synthetic rubber, and the like.

Furthermore, as the binding agent, a thermosetting resin or a reactive resin can be used, and examples thereof include a phenol resin, an epoxy resin, a urea resin, a melamine resin, an alkyd resin, a silicone resin, a polyamine resin, a urea-formaldehyde resin, and the like.

Furthermore, a polar functional group such as —SO₃M, —OSO₃M, —COOM, or P═O(OM)₂ can be introduced into each binding agent described above for the purpose of improving the dispersibility of the magnetic powder. Here, in the formula, M represents a hydrogen atom or an alkali metal such as lithium, potassium, or sodium.

Moreover, examples of the polar functional group include side-chain types with terminal —NR1R2 and —NR1R2R3⁺X⁻ groups and main-chain types with >NR1R2⁺X⁻ groups. Here, in the formula, R1, R2, and R3 represent hydrogen atoms or hydrocarbon groups, and X⁻ represents a halogen element ion such as fluorine, chlorine, bromine, or iodine, or an inorganic or organic ion. Furthermore, examples of the polar functional group include —OH, —SH, —CN, and epoxy groups.

### (Additive)

The magnetic layer 13 can further contain, as non-magnetic reinforcing particles, aluminum oxide (α, β, or γ alumina), chromium oxide, silicon oxide, diamond, garnet, emery, boron nitride, titanium carbide, silicon carbide, titanium carbide, and titanium oxide (rutile or anatase type titanium oxide) or the like.

### (Underlayer)

The underlayer 12 is a non-magnetic layer containing a non-magnetic powder and a binding agent as main components. The above description regarding the binding agent contained in the magnetic layer 13 also applies to the binding agent contained in the underlayer 12. The underlayer 12 can further contain at least one additive of conductive particles, a lubricant, a curing agent, a rust inhibitor, or the like as necessary.

### (Non-Magnetic Powder)

The non-magnetic powder contained in the underlayer 12 can contain, for example, at least one selected from inorganic particles and organic particles. One kind of non-magnetic powder can be used alone, or two or more kinds of non-magnetic powders can be used in combination. The inorganic particles contain, for example, one or a combination of two or more selected from metal, metal oxide, metal carbonate, metal sulfate, metal nitride, metal carbide, and metal sulfide. More specifically, the inorganic particles can contain, for example, one or two or more selected from iron oxyhydroxide, hematite, titanium oxide, and carbon black. Examples of the shape of the non-magnetic powder include various shapes such as an acicular shape, a spherical shape, a cubic shape, and a plate shape, but are not limited to these shapes.

### (Back Layer)

The back layer 14 can contain a binding agent and a non-magnetic powder. The back layer 14 can contain various additives such as a lubricant, a curing agent, and an antistatic agent as necessary. The above description regarding the binding agent and the non-magnetic powder contained in the underlayer 12 also applies to the binding agent and the non-magnetic powder contained in the back layer 14.

The average particle size of the inorganic particles contained in the back layer 14 is preferably 10 nm or more and 150 nm or less, and more preferably 15 nm or more and 110 nm or less. The average particle size of the inorganic particles is determined in a similar manner to the average particle size D of the magnetic powder described above.

### (3) Physical Properties and Structure

### (Surface Roughness Rab)

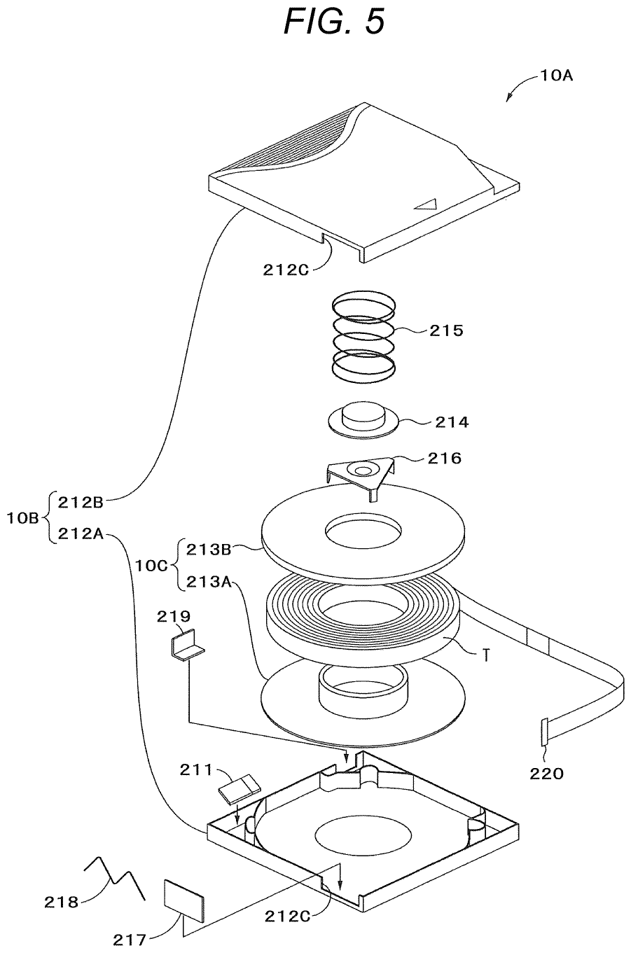

The surface roughness Rab is a value measured on a surface 13S of the magnetic layer 13 of the cleaning tape 10. The surface roughness Rab is determined as follows. First, a cleaning tape T accommodated in a cartridge 10A illustrated in FIG. 5 is unwound, and the cleaning tape T is cut out by about 10 cm at a position from 30 m to 40 m in the longitudinal direction from a connection portion between the cleaning tape T and a leader tape LT and attached to a slide glass (that is, the surface of the back layer is attached to the slide glass) to obtain a sample piece. Next, the surface roughness of the surface 13S of the magnetic layer of the sample piece is measured by a non-contact roughness meter using the following light interference.

### <Surface Roughness Measurement Conditions>

Device: Non-contact roughness meter using optical interference
(non-contact surface/layer cross-sectional shape measurement system VertScan R5500GL-M100-AC manufactured by Ryoka Systems Inc.)
Objective lens: 20× (approximately 236 μm×177 μm field of view)
Resolution: 640 points×480 points
Measurement mode: phase
Wavelength filter: 520 nm
Surface correction: correction using a quartic polynomial approximation surface

As described above, the surface roughness is measured at at least five or more positions in the longitudinal direction, and then the average value of arithmetic average roughnesses Sa (nm) automatically calculated from surface profiles obtained at the respective positions is taken as the surface roughness Rab (nm).

### (Abrasivity)

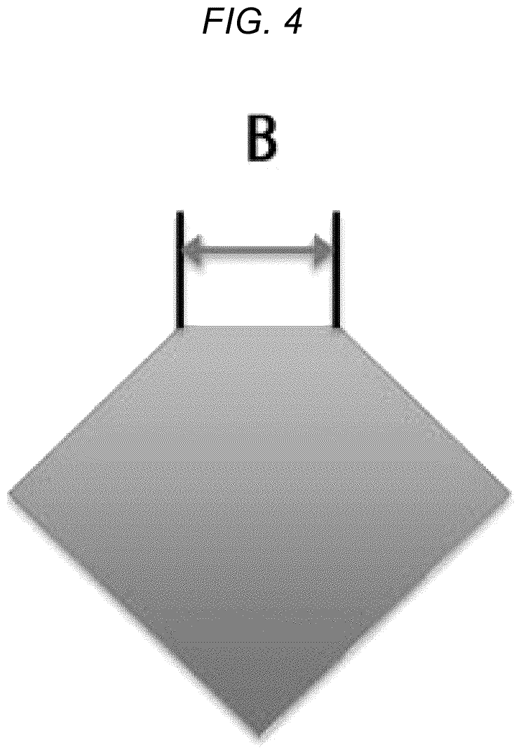

The abrasivity is measured according to ECMA-319 Annex C. Note that the abrasivity is measured by changing the ceramic material of the abrasivity bar to AlFeSil. The abrasivity means an index indicating the degree of wear of the magnetic head due to the magnetic surface of the cleaning tape by the cleaning tape coming into contact with the magnetic head and traveling. For example, a square pillar bar (abrasivity bar) A formed using a ceramic material (AlFeSil) illustrated in FIG. 3 is set in a dedicated jig (a jig described in ECMA-319 Annex C) illustrated in FIG. 2, the square pillar bar is attached to a magnetic head portion such as a tape drive such that corners of the square pillar come into contact with the cleaning tape, the cleaning tape is caused to travel for a predetermined time or a predetermined number of passes, and after traveling, a width B of the worn abrasivity bar as illustrated in FIG. 4 is measured. In the measurement, a TOPCON universal tool microscope or a microscope having equivalent performance is used. The measured wear amount (scraping amount) of the abrasivity bar is used as an index of abrasivity. The greater the wear amount (scraping amount), the better the abrasivity and the greater the polishing force. For example, the abrasivity is measured as follows.

The square pillar bar (abrasivity bar) A formed using a ceramic material (AlFeSil) illustrated in FIG. 3 is set in the dedicated jig illustrated in FIG. 2.

Note that the square pillar bar (abrasivity bar) A is obtained by subjecting a ceramic material (Al: 5.4%, Si: 9.6%, Fe: 85%) to a heat treatment at 1000° C. and vacuum molding, and has a Rockwell C hardness of 46. Next, the square pillar bar is attached to the magnetic head portion such as a tape drive such that corners of the square pillar bar come into contact with the cleaning tape. Thereafter, the cleaning tape is caused to travel under the following conditions.
Tape speed: 3.0 m/sec
Tension 1.0 N±0.1 N
Wrap angle: 12°
Traveling tape length: 580 m

The average wear pattern length of the abrasivity bar described above is preferably 12.5 μm to 20 μm after a new cleaning tape is caused to travel 50 times back and forth. When the similar measurement is repeated at the same portion as the cleaning tape, the wear pattern length is within 30%. The measurement is performed under an environment of a temperature of 23° C.±2° C. and a humidity of 45%±5%. The average wear pattern length of the abrasivity bar of the cleaning tape is set within a maximum of 20 μm after the cleaning tape is caused to travel 50 times back and forth. After the cleaning tape is caused to travel 50 times back and forth, the wear amount (scraping amount) is measured at three positions, and the measured values are simply averaged (arithmetically averaged) to obtain a measured value of the wear amount (scraping amount). This measured value is defined as the abrasivity of 50 reciprocations. Note that the above-described three measurement positions are randomly selected from the sample so as to be different points in the width direction of the cleaning tape. The same applies hereinafter.

Thereafter, the abrasivity bar is replaced with a new one, the cleaning tape after being caused to travel 50 times back and forth is used, and the wear amount (scraping amount) is measured after the cleaning tape is caused to travel 50 times back and forth. This measured value is defined as the abrasivity of 50 reciprocations to 100 reciprocations.

### (Average Thickness (Average Total Thickness) t_{T} of Cleaning Tape)

The average thickness t_{T} of the cleaning tape T is determined as follows. First, the cleaning tape T accommodated in the cartridge 10A is unwound, and the cleaning tape T is cut out in a length of 250 mm at a position 30 m in the longitudinal direction from the connection portion between the cleaning tape T and the leader tape LT to prepare a sample. Next, the thickness of the sample is measured at five points using a laser hologauge (LGH-110C) manufactured by Mitutoyo Corporation as a measuring device, and the average (arithmetic mean) of the measured values is simply calculated to obtain the average thickness t_{T} [μm]. Note that the above-described five measurement positions are randomly selected from the sample so as to be different points in the longitudinal direction of the magnetic tape T.

### (Average Thickness of Underlayer)

The average thickness of the underlayer 12 is determined as follows. First, the cleaning tape T accommodated in the cartridge 10A is unwound, and the cleaning tape T is cut out in a length of 250 mm at three positions 10 m, 30 m, and 50 m in the longitudinal direction from the connection portion between the cleaning tape T and the leader tape LT to prepare three samples. Subsequently, each sample is thin-sectioned using the FIB method or the like. In the case of using an FIB method, as pretreatment for observing a TEM image of a cross section described below, a carbon layer and a tungsten layer are formed as protective films. The carbon layer is formed on both the magnetic layer 13 side and the back layer 14 side of the cleaning tape T by vapor deposition, and then, the tungsten layer is further formed on the magnetic layer 13 side by vapor deposition or sputtering. The thin sectioning is performed along the longitudinal direction of the cleaning tape T. That is, the thin sectioning forms a cross section parallel to both the longitudinal direction and the thickness direction of the cleaning tape T.

The above-described cross section of each thin-sectioned sample thus obtained is observed under the following conditions using a transmission electron microscope (TEM).
Device: TEM (H9000NAR manufactured by Hitachi, Ltd.)
Acceleration voltage: 300 kV
Magnification: 100,000 times

Next, using the obtained TEM image, the thickness of the underlayer 12 is measured at at least 10 or more points in the longitudinal direction of the cleaning tape T, and then the simple average (arithmetic mean) of the measured values is calculated to obtain the average thickness (μm) of the underlayer 12.

### (Average Thickness of Base Layer)

The average thickness of the base layer 11 is determined as follows. First, the cleaning tape T accommodated in the magnetic recording cartridge 10A is unwound, and the magnetic tape T is cut out in a length of 250 mm at a position 30 m in the longitudinal direction from the connection portion between the cleaning tape T and the leader tape LT to prepare a sample. In the present specification, the “longitudinal direction” in the case of the “longitudinal direction from the connection portion between the cleaning tape T and the leader tape LT” refers to a direction from one end adjacent to the leader tape LT toward the other end.

Subsequently, the layers other than the base layer 11 of the sample (that is, the underlayer 12, the magnetic layer 13, and the back layer 14) are removed with a solvent such as methyl ethyl ketone (MEK) or dilute hydrochloric acid. Next, the thickness of the sample (base layer 11) is measured at five positions using a laser hologauge (LGH-110C) manufactured by Mitutoyo Corporation as a measuring device, and the simple average (arithmetic mean) of the measured values is calculated to obtain the average thickness of the base layer 11. Note that the above-described five measurement positions are randomly selected from the sample so as to be different points in the longitudinal direction of the cleaning tape T.

### (Average Thickness t_{b} of Back Layer)

The average thickness t_{b} of the back layer 14 is determined as follows. First, the average thickness (average total thickness) t_{T} of the cleaning tape T is measured. A method for measuring the average thickness t_{T} (average total thickness) is as described in the following “Average thickness of cleaning tape” described above. Subsequently, the cleaning tape T accommodated in the cartridge 10A is unwound, and the cleaning tape T is cut out in a length of 250 mm at a position 30 m in the longitudinal direction from the connection portion between the cleaning tape T and the leader tape LT to prepare a sample. Next, the back layer 14 of the sample is removed with a solvent such as methyl ethyl ketone (MEK) or dilute hydrochloric acid. Next, the thickness of the sample is measured at five positions using a laser hologauge (LGH-110C) manufactured by Mitutoyo Corporation, and the simple average (arithmetic mean) of the measured values is calculated to obtain the average thickness t_{B}[μm]. Thereafter, the average thickness t_{b} [μm] of the back layer 14 is determined by the following equation. Note that the above-described five measurement positions are randomly selected from the sample so as to be different points in the longitudinal direction of the cleaning tape T.

$${t}_{b} [ μm ] = {t}_{T} [ μm ] - {t}_{B} [ μm ]$$

### (Average Thickness tₘ of Magnetic Layer)

The average thickness tₘ of the magnetic layer 13 is determined as follows. First, the cleaning tape T accommodated in the cartridge 10A is unwound, and the cleaning tape T is cut out in a length of 250 mm at three positions 10 m, 30 m, and 50 m in the longitudinal direction from the connection portion between the cleaning tape T and the leader tape LT to prepare three samples. Subsequently, each sample is thin-sectioned using the FIB method or the like. In the case of using an FIB method, as pretreatment for observing a TEM image of a cross section described below, a carbon layer and a tungsten layer are formed as protective films. The carbon layer is formed on both the magnetic layer 13 side and the back layer 14 side of the cleaning tape T by vapor deposition, and then, the tungsten layer is further formed on the magnetic layer 13 side by vapor deposition or sputtering. The thin sectioning is performed along the longitudinal direction of the cleaning tape T. That is, the thin sectioning forms a cross section parallel to both the longitudinal direction and the thickness direction of the cleaning tape T.

The above-described cross section of each obtained thin-sectioned sample is observed under the following conditions using a transmission electron microscope (TEM) to obtain a TEM image of each thin-sectioned sample. Note that the magnification and acceleration voltage can be appropriately adjusted according to the type of the device.
Device: TEM (H9000NAR manufactured by Hitachi, Ltd.)
Acceleration voltage: 300 kV
Magnification: 100,000 times

Next, the thickness of the magnetic layer 13 is measured at 10 positions of each thin-sectioned sample using the TEM image of each thin-sectioned sample thus obtained. Note that the 10 measurement positions of each thin-sectioned sample are randomly selected from the sample so as to be different positions in the longitudinal direction of the cleaning tape T. An average value obtained by calculating the simple average (arithmetic mean) of the measured values (thicknesses of the magnetic layer 13 at 30 positions in total) of each thin-sectioned sample is defined as the average thickness tₘ [nm] of the magnetic layer 13.

### (Average Particle Size of Magnetic Powder)

In a case where the magnetic powder contains a hexagonal ferrite particle powder, the average particle size and average aspect ratio of the magnetic powder are determined as follows. First, the cleaning tape T accommodated in the cartridge 10A is unwound, and the cleaning tape T is cut out at a position 30 m in the longitudinal direction from the connection portion between the cleaning tape T and the leader tape LT. Subsequently, the cleaning tape T to be measured is thin-sectioned using the FIB method or the like. In the case of using an FIB method, as pretreatment for observing a TEM image of a cross section described below, a carbon layer and a tungsten layer are formed as protective films. The carbon layer is formed on both the magnetic layer 13 side and the back layer 14 side of the cleaning tape T by vapor deposition, and then, the tungsten layer is further formed on the magnetic layer 13 side by vapor deposition or sputtering. The thin sectioning is performed along the length direction (longitudinal direction) of the cleaning tape T. That is, the thin sectioning forms a cross section parallel to both the longitudinal direction and the thickness direction of the cleaning tape T.

Using a transmission electron microscope (H-9500 manufactured by Hitachi High-Technologies Corporation), the cross section of the obtained thin-sectioned sample is observed at an acceleration voltage of 200 kV and a total magnification of 500,000 times such that the entire magnetic layer 13 is included in the thickness direction of the magnetic layer 13, and a TEM photograph is imaged. The TEM photograph is prepared in sufficient quantity to allow the extraction of 50 particles whose plate diameter DB and plate thickness DA (see FIG. 27) described below can be measured.

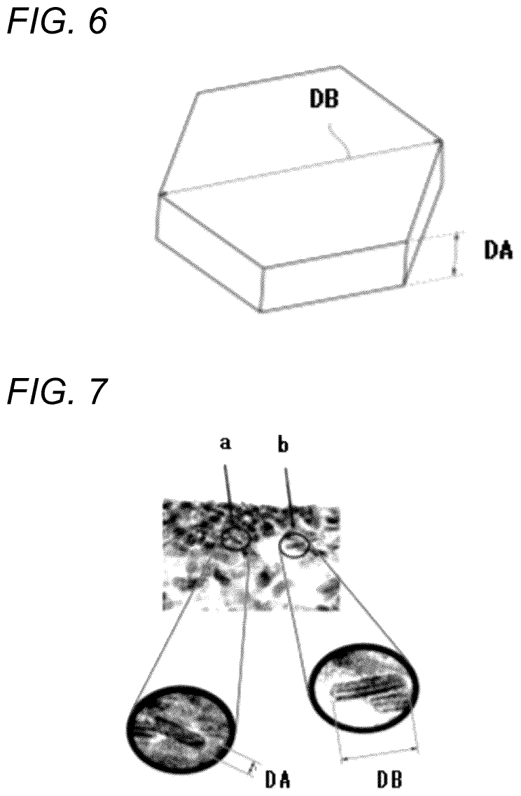

In the present specification, as for the size of the hexagonal ferrite particles (hereinafter, referred to as “particle size”), in a case where the shape of the particles observed in the TEM photograph described above is a plate shape or a columnar shape (provided that, the thickness or height is smaller than the major axis of the plate surface or the bottom surface) as illustrated in FIG. 6, the major axis of the plate surface or the bottom surface is taken as the value of the plate diameter DB. The thickness or height of the particles observed in the TEM photograph described above is defined as the value of the plate thickness DA. In a case where the plate surface or bottom surface of the particles observed in the TEM photograph has a hexagonal shape, the major diameter refers to the longest diagonal distance. In a case where the thickness or height of a single particle is not uniform, the maximum thickness or height of the particle is defined as the plate thickness DA.

Next, 50 particles extracted from the imaged TEM photograph are selected on the basis of the following criteria. A particle that is partially outside the field of view of the TEM photograph is not measured, and a particle that is well-defined and isolated is measured. In a case where particles overlap with each other, particles with clear boundaries and discernible overall shapes are each measured as a single particle, but particles with unclear boundaries and indiscernible overall shapes are not measured due to inability to determine their shapes.

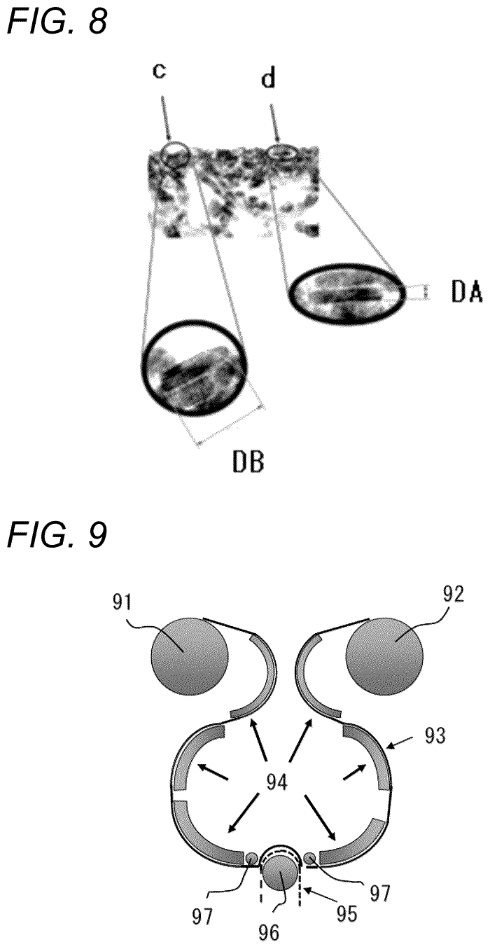

FIGS. 7 and 8 show an example of the TEM photograph. In FIGS. 7 and 8, for example, the particles indicated by arrows a and d are selected because the plate thickness (thickness or height of the particles) DA of the particles can be clearly confirmed. The plate thickness DA of each of the selected 50 particles is measured. The average (arithmetic mean) of the plate thicknesses DA thus determined is simply calculated to determine an average plate thickness DAₐᵥₑ. The average plate thickness DAₐᵥₑ is an average particle plate thickness. Subsequently, the plate diameter DB of each magnetic powder is measured. In order to measure the plate diameter DB of the particles, 50 particles whose plate diameters DB are clearly visible are selected from the imaged TEM photograph. For example, in FIGS. 7 and 8, for example, the particles indicated by arrows b and c are selected because the plate diameter DB of the particles can be clearly confirmed. The plate diameter DB of each of the selected 50 particles is measured. The average (arithmetic mean) of the plate diameters DB thus determined is simply calculated to determine an average plate diameter DBₐᵥₑ. The average plate diameter DBₐᵥₑ is an average particle size. Then, an average aspect ratio (DBₐᵥₑ/DAₐᵥₑ) of the particle is determined from the average plate thickness DAₐᵥₑ and the average plate diameter DBₐᵥₑ.

### (Average Particle Volume of Magnetic Powder)

The average particle volume of the magnetic powder is determined as follows. First, as described above regarding the method for calculating the average particle size of the magnetic powder, the average plate thickness DAₐᵥₑ and the average plate diameter DBₐᵥₑ are determined. Next, an average particle volume V of the magnetic powder is determined by the following equation.

$$V = \frac{3 \sqrt{3}}{8} \times {DA}_{ave} \times {DB}_{ave} \times {DB}_{ave} \qquad [ Math . 1 ]$$

### (Electric Resistance)

An electrode having an inter-electrode distance of 12.65 mm is used, a test piece (tape width 12.65 mm) is placed on the electrode with the surface of the magnetic layer facing down, a load of 1.62 N is applied to both ends, an additional voltage is applied, and after 1 minute from the application, measurement is performed with an electric resistance measuring machine (ULTRA HIGH RESISTANCE METER R8340A, manufactured by ADVATEST CORPORATION). Note that additional voltage refers to a voltage actually applied to the test piece at the time of measurement. The additional voltage at the time of measurement is set as follows by a resistance value R.
When the resistance value R>5×10⁴ Ω/sq:
Applied voltage: 100±10 V
When 5×10⁴ Ω/sq>the resistance value R>5×10³ Ω/sq:
Applied voltage: 10±1 V
When the resistance value R<5×10³ Ω/sq:
Applied voltage: maximum voltage at which the cleaning tape is not deformed

### (4) Method for Manufacturing Cleaning Tape

Next, a method for manufacturing the cleaning tape 10 having the above-described configuration will be described. First, an underlayer forming coating material is prepared by kneading and/or dispersing a non-magnetic powder, a binding agent, and the like in a solvent. Next, a magnetic layer forming coating material is prepared by kneading and/or dispersing a magnetic powder, a binding agent, and the like in a solvent. For the preparation of the magnetic layer forming coating material and the underlayer forming coating material, for example, the following solvent, dispersing device, and kneading device can be used.

Examples of the solvent used for preparing the above-described coating materials include: ketone-based solvents such as acetone, methyl ethyl ketone, methyl isobutyl ketone, and cyclohexanone; alcohol-based solvents such as methanol, ethanol, and propanol; ester-based solvents such as methyl acetate, ethyl acetate, butyl acetate, propyl acetate, ethyl lactate, and ethylene glycol acetate; ether-based solvents such as diethylene glycol dimethyl ether, 2-ethoxyethanol, tetrahydrofuran, and dioxane; aromatic hydrocarbon-based solvents such as benzene, toluene, and xylene; and halogenated hydrocarbon-based solvents such as methylene chloride, ethylene chloride, carbon tetrachloride, chloroform, and chlorobenzene. One of the above solvents can be used, or a mixture of two or more of the solvents can be used.

As the kneading device used for preparing the above-described coating materials, for example, kneading devices such as a continuous twin-screw kneader, continuous twin-screw kneader capable of performing dilution in multi-stages, a kneader, a pressure kneader, and a roll kneader can be used, but the kneading device is not particularly limited to these devices. Furthermore, as the dispersing device used for preparing the above-described coating materials, for example, dispersing devices such as a roll mill, a ball mill, a horizontal sand mill, a vertical sand mill, a spike mill, a pin mill, a tower mill, a pearl mill (for example, “DCP mill” manufactured by Nippon Eirich Co., Ltd.), a homogenizer, and an ultrasonic dispersion machine can be used, but the dispersing device is not particularly limited to these devices.

Next, the underlayer forming coating material is applied to one of the main surfaces of the base layer 11 and dried to form the underlayer 12. Subsequently, the magnetic layer forming coating material is applied onto the underlayer 12 and dried to form the magnetic layer 13 on the underlayer 12.

Thereafter, the obtained cleaning tape 10 is rewound around a large-diameter core and is subjected to curing treatment. Finally, the cleaning tape 10 is subjected to calendering treatment and then cut into a predetermined width (for example, ½ inch wide). Note that, from the viewpoint of maintaining an appropriate polishing force, the calendering treatment temperature can be preferably 95° C. or lower, more preferably 90° C. or lower, and further preferably 85° C. or lower. As a result, the intended elongated cleaning tape 10 is obtained.

### (5) One Embodiment of Cleaning Tape Cartridge

### [Configuration of Cartridge]

The cleaning tape according to the present technology can be accommodated in a cleaning tape cartridge and used. In the cleaning cartridge, the cleaning tape can be wound around, for example, a reel.

An example of a configuration of the cleaning tape cartridge 10A including the cleaning tape T having the above-described configuration will be described with reference to FIG. 5.

FIG. 5 is an exploded perspective view illustrating an example of a configuration of the cleaning tape cartridge 10A. The cleaning tape cartridge 10A is a cleaning tape cartridge conforming to the linear tape-open (LTO) standard, and includes, inside a cartridge case 10B including a lower shell 212A and an upper shell 212B, a reel 10C in which the cleaning tape T is wound, a reel lock 214 and a reel spring 215 for locking rotation of the reel 10C, a spider 216 for unlocking the locking state of the reel 10C, a slide door 217 for opening and closing a tape outlet 212C provided in the cartridge case 10B across the lower shell 212A and the upper shell 212B, a door spring 218 for energizing the slide door 217 to the closed position of the tape outlet 212C, a write protect 219 for preventing erroneous erasure, and a cartridge memory 211. The reel 10C has an approximately disk shape with an opening at its center, and includes a reel hub 213A and a flange 213B, both including a rigid material such as plastic. The cleaning tape T has one end connected to the leader tape LT. A leader pin 220 is provided at a distal end of the leader tape LT.

The present technology can also adopt the following configurations.

[1]

A cleaning tape including: a magnetic layer; and an underlayer in this order, in which
an average thickness of the underlayer is 1.60 μm or more,
a surface roughness Rab of a surface of the magnetic layer is 2.9 nm or less, and
an abrasivity of 50 reciprocations with respect to an AlFeSil prism is 65 μm or less, and an abrasivity of 50 reciprocations to 100 reciprocations with respect to the AlFeSil prism is 25 μm or more.

[2]

The cleaning tape according to [1], in which the magnetic layer contains a magnetic powder.

[3]

The cleaning tape according to [1] or [2], in which the magnetic powder contains barium ferrite.

[4]

The cleaning tape according to any one of [1] to [3], in which the average thickness (average total thickness) is 9.2 μm or less.

[5]

The cleaning tape according to any one of [1] to [4], in which the average thickness of the underlayer is 1.85 μm or less.

[6]

The cleaning tape according to any one of [1] to [5], in which when a standard cleaning tape is slid while being brought into contact with a surface of a polishing tape for a magnetic medium, and then a region of a part of the surface, which is in contact with the standard cleaning tape, of the polishing tape for a magnetic medium is imaged, among pixels constituting a captured image, a ratio (dusting rate) of a proportion of a pixel in which powder adhering to the polishing tape for a magnetic medium due to dusting from the cleaning tape to be inspected is imaged to a proportion of a pixel in which powder adhering to the polishing tape for a magnetic medium due to dusting from the standard cleaning tape is imaged is more than 1.0.

[7]

The cleaning tape according to [3], in which an average particle volume of the barium ferrite magnetic powder is 500 nm³ to 2000 nm³.

[8]

The cleaning tape according to [1], further including abrasive particles in the magnetic layer.

[9]

The cleaning tape according to [8], in which the abrasive particles are alumina particles.

[10]

The cleaning tape according to [9], in which an average particle size of the alumina particles is 20 nm to 80 nm.

[11]

The cleaning tape according to any one of [1] to [10], in which an electric resistance value of the surface of the magnetic layer of the cleaning tape is 1×10³ Ω/sq to 5×10¹⁰ Ω/sq.

[12]

The cleaning tape according to any one of [1] to [11], in which the average thickness of the underlayer is 1.67 μm or more.

[13]

The cleaning tape according to any one of [1] to [12], further including a magnetic layer, an underlayer, a base layer, and a back layer in this order.

[14]

The cleaning tape according to any one of [1] to [13], in which the average thickness (average total thickness) is 8.80 μm or less.

[15]

The cleaning tape according to any one of [1] to [14], which is a cleaning tape for a magnetic recording system.

### 3. EXAMPLES

Hereinafter, the present technology will be described specifically with reference to Examples, but the present technology is not limited only to these Examples.

In the present example, the surface roughness of the surface of the magnetic layer, the abrasivity, the average thickness (average total thickness) t_{T} of the cleaning tape, the average thickness tₘ of the magnetic layer, the average thickness of the underlayer, the average thickness of the base layer, the average thickness of the back layer, and the electric resistance are determined by the measurement methods described in the above-described embodiment.

Furthermore, the dusting rate, the cleaning power, and the head damage were measured as follows.

### (Dusting Rate)

When a standard cleaning tape is slid while being brought into contact with a surface of a polishing tape for a magnetic medium, and then a region of a part of the surface, which is in contact with the standard cleaning tape, of the polishing tape for a magnetic medium is imaged, among pixels constituting a captured image, the dusting rate refers to a ratio of a proportion of a pixel in which powder adhering to the polishing tape for a magnetic medium due to dusting from the cleaning tape to be inspected is imaged to a proportion of a pixel in which powder adhering to the polishing tape for a magnetic medium due to dusting from the standard cleaning tape.

### <Sample Preparation>

An evaluation sample for the dusting rate was prepared as follows. First, a rewinding machine illustrated in FIG. 9 was prepared, and a cleaning tape 93 was set in the rewinding machine. Specifically, before the cleaning tape 93 having an elongated shape was unwound from an unwinding reel 92 and wound by a winding reel 91, the cleaning tape was set on six arc-shaped tape traveling guides 94 and two substantially cylindrical and rod-shaped rollers 97 such that the back surface of the cleaning tape was in contact with these tape traveling guides and rollers. Furthermore, the magnetic surface side of the cleaning tape 93 was set so as to be in contact with the surface of a polishing tape for a magnetic medium (WA4000, manufactured by Mipox Corporation) 95 wound around the surface of a drive head 96. Note that the polishing tape for a magnetic medium 95 was a film coated with abrasive particles of the level of several μm.

The six tape traveling guides 94 (particularly, surfaces thereof) and the two rollers 97 were all formed using stainless steel SUS304.

The arrangement of the six arc-shaped tape traveling guides 94 will be described with reference to FIG. 9. As illustrated in FIG. 9, the cleaning tape 93 was set on the six tape traveling guides 94. Hereinafter, the six tape traveling guides 94 are referred to as a “first tape traveling guide”, a “second tape traveling guide”, a “third tape traveling guide”, a “fourth tape traveling guide”, a “fifth tape traveling guide”, and a “sixth tape traveling guide” from the side closest to the unwinding reel 92. A distance d1 at which the tape did not follow the tape traveling guide between the first tape traveling guide and the second tape traveling guide was about 20 mm. A distance d2 at which the tape did not follow the tape traveling guide between the second tape traveling guide and the third tape traveling guide was about 20 mm. The two rollers 97 were set between the third tape traveling guide and the fourth tape traveling guide. The diameter of each of these two rollers 97 was 7 mm. Hereinafter, the two rollers 97 will be referred to as a “first roller” and a “second roller” from the side closest to the unwinding reel 92. Between the first roller and the second roller, the cleaning tape 93 was set so as to be in contact with the surface of the polishing tape for a magnetic medium (WA4000, manufactured by Mipox Corporation) 95 wound around the surface of the drive head 96 at a holding angle of 10°. A distance d5 at which the tape did not follow the tape traveling guide between the fourth tape traveling guide and the fifth tape traveling guide was about 20 mm. A distance d6 at which the tape did not follow the tape traveling guide between the fifth tape traveling guide and the sixth tape traveling guide was about 20 mm. Furthermore, the six tape traveling guides were fixed so as not to rotate, but the rollers 97 were rotatable.

The cleaning tape 93 was held on the tape traveling guides 94, the rollers 97, and the drive head 96 so as not to move in the width direction of the cleaning tape 93.

The evaluation sample for the dusting rate was prepared as follows.

The cleaning tape 93 was unwound from the unwinding reel 92 and was caused to travel under the following conditions while being brought into contact with the polishing tape for a magnetic medium 95 wound around the surface of the drive head 96 to obtain, as a sample, the polishing tape for a magnetic medium 95 to which powder dropped from the cleaning tape 93 was attached. The size of the sample was 13 mm in the longitudinal direction×10 mm in the width direction. Note that the N number of the sample was 3. Note that, in addition to the evaluation samples of Examples and Comparative Examples to be inspected, a reference sample was prepared in a similar manner using a commercially available cleaning tape (cleaning tape for LTO commercially available before 2022, manufactured by Sony Group Corporation) as a standard cleaning tape as a reference.

### <Traveling Conditions>

Traveling mode: 400 m×5 reciprocations
Tension: 1 N
Travel speed: 3 m/s
Holding angle: 10°

### <Quantification>

With respect to the evaluation sample to be tested and the reference sample prepared as described above, powder adhering to the surface of the polishing tape for a magnetic medium was quantified and evaluated as dirt.

The evaluation was performed as follows.

The evaluation sample and the reference sample were imaged in black and white at a magnification of 25 times and an exposure time of 1/20 seconds using a stereoscopic microscope (SZX16, manufactured by Olympus Corporation).

Data of an image captured by a stereoscopic microscope is binarized by a computer and converted into image data in which each pixel is white or black. More specifically, using image processing software (Image J), binarization processing is performed under the processing conditions described below.

### <Binarization Processing Conditions for Obtaining Information Regarding Contamination Due to Dusting>

Software: Image J Ver 1.44p
Brightness: −100
Clarity: +100

The threshold value at the time of performing the binarization processing was set so that the area occupied by the portion where there was no dusting from the cleaning tape and the powder did not adhere to the polishing tape for a magnetic medium was determined as the white area, and the area of the portion where there was dusting from the cleaning tape and the powder adhered to the polishing tape for a magnetic medium was determined as the black area. Specifically, the image data of the reference sample was binarized, and the black-and-white determination threshold was adjusted so that the black area in the image data was 30 to 50%. Also for the image of the evaluation sample, the black area was measured with the same black-and-white determination threshold.

Then, both the evaluation sample and the reference sample were subjected to the above processing, and a ratio of the black area of the evaluation sample to the black area of the reference sample was determined as dusting as shown in the following formula (1) on the basis of these results.

$$Dusting rate = black area of evaluation sample \text{} / black area of reference sample \qquad ( 1 )$$

Here, the dusting rate means a ratio of a degree of dusting falling off from the cleaning paper for evaluation to a degree of dusting falling off from the commercially available cleaning paper as a reference.

The dusting rate can be preferably less than 1.0, preferably 0.8 or less, more preferably 0.6 or less, and further preferably 0.5 or less.

Note that, when the dusting rate was more than 1.0, it was evaluated that the dusting property was inferior to that of the reference sample.

### (Cleaning Power)

In a drive with a reduced error rate, whether the error rate was recovered after use of the cleaning tape was checked. The drive with a reduced error rate was used due to magnetic head contamination. The cleaning process was performed under the following conditions. The error rate was measured using the drive subjected to the cleaning process.

### <Cleaning Conditions>

Tension: 1 N
Number of reciprocations: 3

### <Measurement of Error Rate>

A recording signal was recorded on a commercially available ½ inch magnetic tape (LTO (linear tape open)-9, manufactured by Sony Group Corporation) at a recording density corresponding to that of the commercially available LTO-9 using a magnetic head of a commercially available LTO-9 drive together with a tape traveling system manufactured by Mountain Engineering II. Thereafter, the error rate of the magnetic tape after traveling for 24 hours from the initial time was measured in an environment of 23° C. and a relative humidity of 50%. The results thereof are shown in Table 1. Note that, in Table 1, the cleaning power was determined according to the following criteria on the basis of the measured error rate.
OK (good): The bit error rate is less than 5×10⁻³.
NG (poor): The bit error rate is 5×10⁻³ or more.

### (Head Damage)

In three environments of a room temperature environment, an environment at 35° C. and a relative humidity of 20% RH, and an environment at 26° C. and a relative humidity of 80% RH, a magnetic head of an LTO-9 drive was used, a flexible part of the drive was first removed, and an electric resistance value of the magnetic head was measured by an electric resistance measuring machine manufactured by ADVANTEST CORPORATION. Thereafter, cleaning was performed 56 times on the magnetic head using the cartridge storing the cleaning tape. After the cleaning, the electric resistance value of the magnetic head was measured with an electric resistance measuring machine manufactured by ADVANTEST CORPORATION.

The damage to the magnetic head was evaluated by the following head resistance change rate.

$$Head resistance change rate = ( magnetic head electric resistance value after cleaning process / magnetic head electric resistance value before cleaning process )$$

The damage to the magnetic head was evaluated according to the following criteria.

Without head damage: The head resistance change rate is more than 20%.

With head damage: The head resistance change rate is 20% or less.

### Example 1

### (Preparation Step of Magnetic Layer Forming Coating Material)

A magnetic layer forming coating material was prepared as follows. First, a first composition having the following formulation was kneaded with an extruder. Next, the kneaded first composition and a second composition having the following formulation were added to a stirring tank equipped with a disperser, and premixing was performed. Subsequently, sand mill mixing was further performed and filter treatment was performed to prepare a magnetic layer forming coating material.

### (First Composition)

Magnetic powder (hexagonal ferrite having M-type structure, composition: Ba-Ferrite, shape: plate-shaped hexagonal particles, average particle volume: 1600 nm³): 100 parts by mass
Vinyl chloride-based resin (cyclohexanone solution 30 mass %): 46 parts by mass
(Degree of polymerization 300, Mn=10000, containing OSO₃K=0.07 mmol/g, and secondary OH=0.3 mmol/g as a polar group)

### (Second Composition)

Vinyl chloride-based resin: 1.6 parts by mass
(cyclohexanone solution 30 mass % as a resin)
n-Butyl stearate: 2 parts by mass
Methyl ethyl ketone: 121.3 parts by mass
Toluene: 121.3 parts by mass
Cyclohexanone: 60.7 parts by mass
Aluminum oxide powder: 7.5 parts by mass
(α-Al₂O₃, average particle diameter: 50 nm, trade name: HIT100, manufactured by Sumitomo Chemical Co., Ltd., Mohs hardness: 9)
Carbon black: 2.0 parts by mass
(average particle diameter: 70 nm, trade name: SEAST TA, manufactured by TOKAI CARBON CO., LTD.)

Finally, 2 parts by mass of polyisocyanate (trade name: Coronate L, manufactured by Nippon Polyurethane Industry Co., Ltd.) as a curing agent and 2 parts by mass of myristic acid were added to the magnetic layer forming coating material prepared as described above.

### (Preparation Step of Underlayer Forming Coating Material)

An underlayer forming coating material was prepared as follows. First, a third composition having the following formulation was kneaded with an extruder. Next, the kneaded third composition and a fourth composition having the following formulation were added to a stirring tank equipped with a disperser, and premixing was performed. Subsequently, sand mill mixing was further performed and filter treatment was performed to prepare an underlayer forming coating material.

### (Third Composition)

Acicular iron oxide powder: 100 parts by mass
(α-Fe₂O₃, average major axis length 0.15 μm)
Aluminum oxide powder: 5 parts by mass (α-Al₂O₃, average particle diameter: 80 nm, trade name: HIT82, manufactured by Sumitomo Chemical Co., Ltd., Mohs hardness: 9)
Vinyl chloride-based resin: 55.6 parts by mass
(resin solution: resin content 30 mass %, cyclohexanone 70 mass %)

### (Fourth Composition)

Polyurethane-based resin UR8200 (manufactured by TOYOBO CO., LTD.): 18.5 parts by mass
n-Butyl stearate: 2 parts by mass
Methyl ethyl ketone: 108.2 parts by mass
Toluene: 108.2 parts by mass
Cyclohexanone: 18.5 parts by mass
Carbon black: 10 parts by mass
(average particle diameter: 20 nm)

Finally, 2 parts by mass of polyisocyanate (trade name: Coronate L, manufactured by Tosoh Corporation) as a curing agent and 2 parts by mass of myristic acid were added to the underlayer forming coating material prepared as described above.

### (Preparation Step of Back Layer Forming Coating Material)

A back layer forming coating material was prepared as follows. The following raw materials were mixed in a stirring tank equipped with a disperser, and filter treatment was performed to prepare the back layer forming coating material. Carbon black (trade name: #80, manufactured by Asahi Carbon Co., Ltd.): 100.0 parts by mass
Polyester polyurethane: 150 parts by mass
(resin solution: blending amount of polyurethane resin 30 mass %, blending amount of cyclohexanone 70 mass %)
(trade name: N-2304, manufactured by Nippon Polyurethane Industry Co., Ltd.)
Methyl ethyl ketone: 500 parts by mass
Toluene: 400 parts by mass
Cyclohexanone: 100 parts by mass
Polyisocyanate (trade name: Coronate L, manufactured by TOSOH CORPORATION): 9 parts by mass

### (Film Forming Step)

A cleaning tape was prepared as described below using the coating materials prepared as described above.

First, as a support to be a base layer of a cleaning tape, a PEN film (base film) having an elongated shape and an average thickness of 6.57 μm was prepared. Next, the underlayer forming coating material was applied onto one main surface of the PEN film and dried to form an underlayer on the one main surface of the PEN film so that the underlayer in a final product had an average thickness of 1.80 μm. Next, the magnetic layer forming coating material was applied onto the underlayer and dried to form a magnetic layer on the underlayer so that the magnetic layer in a final product had an average thickness of 0.07 μm.

Subsequently, the PEN film on which the underlayer and the magnetic layer were formed was subjected to curing treatment. Thereafter, calendering treatment was performed at a calender temperature of 80° C. to smooth the surface of the magnetic layer.

### (Cutting Step)

The cleaning tape obtained as described above was cut into a width of ½ inch (12.65 mm). This resulted in a cleaning tape with an elongated shape.

The cleaning tape having a width of ½ inch was wound around a reel provided in a cartridge case to obtain a cleaning tape cartridge.

The obtained cleaning tape had a surface roughness Rab on the magnetic surface side of 2.6 nm, an abrasivity of 50 reciprocations with respect to an AlFeSil prism of 46.8 μm, and an abrasivity of 50 reciprocations to 100 reciprocations with respect to the AlFeSil prism of 29.0 μm. Furthermore, the average thickness (average total thickness) t_{T} of the cleaning tape was 8.90 μm, and the average thickness of the underlayer was 1.80 μm.

### Example 2

A cleaning tape was obtained by the same method as in Example 1, except that the following conditions were changed from Example 1: the average thickness (average total thickness) t_{T} of the cleaning tape was 8.75 μm, the average thickness of the underlayer was 1.65 μm, the average thickness of the base layer was 6.56 μm, and the average thickness of the back layer was 0.47 μm. The obtained cleaning tape had a surface roughness Rab on the magnetic surface side of 2.5 nm, an abrasivity of 50 reciprocations with respect to an AlFeSil prism of 45.8 μm, and an abrasivity of 50 reciprocations to 100 reciprocations with respect to the AlFeSil prism of 26.3 μm.

### Comparative Example 1

A cleaning tape was obtained by the same method as in Example 1, except that the following conditions were changed from Example 1: the average thickness (average total thickness) t_{T} of the cleaning tape was 8.75 μm, the average thickness of the underlayer was 1.65 μm, the average thickness of the base layer was 6.58 μm, the average thickness of the back layer was 0.45 μm, and the calender temperature was 60° C. The obtained cleaning tape had a surface roughness Rab on the magnetic surface side of 2.7 nm, an abrasivity of 50 reciprocations with respect to an AlFeSil prism of 68.1 μm, and an abrasivity of 50 reciprocations to 100 reciprocations with respect to the AlFeSil prism of 33.4 μm.

### Comparative Example 2

A cleaning tape was obtained by the same method as in Example 1, except that the following conditions were changed from Example 1: the average thickness (average total thickness) t_{T} of the cleaning tape was 8.55 μm, the average thickness of the underlayer was 1.45 μm, the average thickness of the base layer was 6.60 μm, the average thickness of the back layer was 0.43 μm, and the calender temperature was 60° C. The obtained cleaning tape had a surface roughness Rab on the magnetic surface side of 2.9 nm, an abrasivity of 50 reciprocations with respect to an AlFeSil prism of 44.8 μm, and an abrasivity of 50 reciprocations to 100 reciprocations with respect to the AlFeSil prism of 28.6 μm.

### Comparative Example 3

A cleaning tape was obtained by the same method as in Example 1, except that the following conditions were changed from Example 1: the average thickness (average total thickness) t_{T} of the cleaning tape was 8.55 μm, the average thickness of the underlayer was 1.45 μm, the average thickness of the base layer was 6.58 μm, and the average thickness of the back layer was 0.45 μm. The obtained cleaning tape had a surface roughness Rab on the magnetic surface side of 2.7 nm, an abrasivity of 50 reciprocations with respect to an AlFeSil prism of 41.0 μm, and an abrasivity of 50 reciprocations to 100 reciprocations with respect to the AlFeSil prism of 22.5 μm.

### Comparative Example 4

A cleaning tape was obtained by the same method as in Example 1, except that the following conditions were changed from Example 1: the average thickness (average total thickness) t_{T} of the cleaning tape was 8.55 μm, the average thickness of the underlayer was 1.45 μm, the average thickness of the base layer was 6.59 μm, the average thickness of the back layer was 0.44 μm, and the calender temperature was 100° C. The obtained cleaning tape had a surface roughness Rab on the magnetic surface side of 2.3 nm, an abrasivity of 50 reciprocations with respect to an AlFeSil prism of 29.2 μm, and an abrasivity of 50 reciprocations to 100 reciprocations with respect to the AlFeSil prism of 19.2 μm.

### Comparative Example 5

A cleaning tape was obtained by the same method as in Example 1, except that the following conditions were changed from Example 1: a metal magnetic powder (Fe—Co-based acicular magnetic powder, average major axis length: 0.1 μm) was used instead of the barium ferrite magnetic powder, the average thickness of the underlayer of the cleaning tape was 1.45 μm, the average thickness of the base layer was 6.63 μm, the average thickness of the back layer was 0.62 μm, the average thickness of the magnetic layer was 0.20 μm, and the calender temperature was 115° C. The obtained cleaning tape had a surface roughness Rab on the magnetic surface side of 3.1 nm, an abrasivity of 50 reciprocations with respect to an AlFeSil prism of 45.4 μm, and an abrasivity of 50 reciprocations to 100 reciprocations with respect to the AlFeSil prism of 33.1 μm.

Table 1 shows the configurations and evaluation results of the cleaning tapes of Examples 1 and 2 and Comparative Examples 1 to 5.

TABLE 1

| | | Base | Back | Magnetic | Tape | | Surface | | |
|---|---|---|---|---|---|---|---|---|---|
| | Underlayer | layer | layer | layer | total | Calender | roughness | | Electric |
| | thickness | thickness | thickness | thickness | thickness | temperature | Rab | Dusting | resistance |
| | (μm) | (μm) | (μm) | (μm) | (μm) | (° C.) | (nm) | rate | [Ω/cm] |
| Example 1 | 1.80 | 6.57 | 0.46 | 0.07 | 8.90 | 80 | 2.6 | 0.22 | 7.5E+05 |
| Example 2 | 1.65 | 6.56 | 0.47 | 0.07 | 8.75 | 80 | 2.5 | 0.56 | 1.3E+06 |
| Comparative | 1.65 | 6.58 | 0.45 | 0.07 | 8.75 | 60 | 2.7 | 0.95 | 2.3E+06 |
| Example 1 | | | | | | | | | |
| Comparative | 1.45 | 6.60 | 0.43 | 0.07 | 8.55 | 60 | 2.9 | 1.09 | 2.1E+06 |
| Example 2 | | | | | | | | | |
| Comparative | 1.45 | 6.58 | 0.45 | 0.07 | 8.55 | 80 | 2.7 | 0.42 | 1.0E+06 |
| Example 3 | | | | | | | | | |
| Comparative | 1.45 | 6.59 | 0.44 | 0.07 | 8.55 | 100 | 2.3 | 0.11 | 6.9E+05 |
| Example 4 | | | | | | | | | |
| Comparative | 1.45 | 6.63 | 0.62 | 0.20 | 8.90 | 115 | 3.1 | 1.00 | 1.1E+06 |
| Example 5 | | | | | | | | | |

| | | | | | | Head damage | |
|---|---|---|---|---|---|---|---|
| | | | Cleaning power | | | Head | Head |
| | Abrasivity (μm) | | Cleaning | Error rate | Error rate | damage | resistance |
| | 50 | 50 to 100 | power | before | after | after | change rate |
| | reciprocations | reciprocations | evaluation | cleaning | cleaning | cleaning | (%) |
| Example 1 | 46.8 | 29.0 | OK | Unmeasurable | 1.7E−03 | Absent | 96 |
| Example 2 | 45.8 | 26.3 | OK | Unmeasurable | 2.3E−03 | Absent | 97 |
| Comparative | 68.1 | 33.4 | OK | Unmeasurable | 1.2E−03 | Present | 5 |
| Example 1 | | | | | | | |
| Comparative | 44.8 | 28.6 | NG | Unmeasurable | 5.1E−02 | Present | 18 |
| Example 2 | | | | | | | |
| Comparative | 41.0 | 22.5 | NG | Unmeasurable | 8.7E−02 | Absent | 96 |
| Example 3 | | | | | | | |
| Comparative | 29.2 | 19.2 | NG | Unmeasurable | 5.2E−01 | Absent | 99 |
| Example 4 | | | | | | | |
| Comparative | 45.4 | 33.1 | NG | Unmeasurable | 9.7E−02 | Absent | 95 |
| Example 5 | | | | | | | |

From the results shown in Table 1, the following can be seen.

In each of the cleaning tapes of Examples 1 and 2, the thickness of the underlayer was 1.60 μm or more, the surface roughness Rab of the surface of the magnetic layer was 2.9 nm or less, the abrasivity of 50 reciprocations with respect to the AlFeSil prism was 65 μm or less, the abrasivity of 50 reciprocations to 100 reciprocations with respect to the AlFeSil prism was 25 μm or more, and the cleaning tape had a favorable cleaning power, and did not cause head damage to the magnetic head. On the other hand, in any of the cleaning tapes of Comparative Examples 3 and 4, the abrasivity of 50 reciprocations to 100 reciprocations with respect to the AlFeSil prism was less than 25 μm, and the cleaning power was not sufficient.

Comparing Example 1 with Comparative Example 5, in the cleaning tape of Example 1, the thickness of the underlayer was 1.60 μm or more, the surface roughness Rab of the surface of the magnetic layer was 2.9 nm or less, the cleaning tape had a favorable cleaning power, and did not cause head damage to the magnetic head. On the other hand, in the cleaning tape of Comparative Example 5, the thickness of the underlayer was less than 1.60 μm, the surface roughness Rab of the surface of the magnetic layer was more than 2.9 nm, and the cleaning power was not sufficient.

Comparing Example 2 with Comparative Example 2, in the cleaning tape of Example 2, the thickness of the underlayer was 1.60 μm or more, the surface roughness Rab of the surface of the magnetic layer was 2.9 nm or less, the cleaning tape had a favorable cleaning power, and did not cause head damage to the magnetic head. On the other hand, in the cleaning tape of Comparative Example 2, the thickness of the underlayer was less than 1.60 μm, the dusting rate was more than 1.0, and the cleaning power was not sufficient.

Although the embodiments and examples of the present technology have been specifically described above, the present technology is not limited to the above-described embodiments and examples, and various modifications based on the technical idea of the present technology are possible.

For example, the configurations, the methods, the processes, the shapes, the materials, the numerical values, and the like described in the embodiments and examples described above are merely examples, and different configurations, methods, processes, shapes, materials, numerical values, and the like can be used as needed. Furthermore, the chemical formulae of compounds and the like are representative and are not limited to the listed valences and the like as long as the compounds have a common name of the same compound.

Furthermore, the configurations, methods, processes, shapes, materials, numerical values, and the like of the above-described embodiments and examples can be combined with each other without departing from the gist of the present technology.

Furthermore, in the present specification, a numerical range indicated by using “to” indicates a range including numerical values described before and after “to” as the minimum value and the maximum value, respectively. In the numerical ranges described in stages in the present specification, the upper limit value or the lower limit value of a numerical range of a certain stage can be replaced with the upper limit value or the lower limit value of a numerical range of another stage. The materials exemplified in the present specification can be used alone or in combination of two or more unless otherwise specified.

### REFERENCE SIGNS LIST

10 Cleaning tape
11 Base layer
12 Underlayer
13 Magnetic layer
14 Back layer

1. A cleaning tape comprising: a magnetic layer; and an underlayer in this order, wherein
an average thickness of the underlayer is 1.60 μm or more,
a surface roughness Rab of a surface of the magnetic layer is 2.9 nm or less, and
an abrasivity of 50 reciprocations with respect to an AlFeSil prism is 65 μm or less, and an abrasivity of 50 reciprocations to 100 reciprocations with respect to the AlFeSil prism is 25 μm or more.

2. The cleaning tape according to claim 1, wherein the magnetic layer contains a magnetic powder.

3. The cleaning tape according to claim 1, wherein the magnetic powder contains barium ferrite.

4. The cleaning tape according to claim 1, wherein the average thickness (average total thickness) is 9.2 μm or less.

5. The cleaning tape according to claim 1, wherein the average thickness of the underlayer is 1.85 μm or less.

6. The cleaning tape according to claim 1, wherein when a standard cleaning tape is slid while being brought into contact with a surface of a polishing tape for a magnetic medium, and then a region of a part of the surface, which is in contact with the standard cleaning tape, of the polishing tape for a magnetic medium is imaged, among pixels constituting a captured image, a ratio (dusting rate) of a proportion of a pixel in which powder adhering to the polishing tape for a magnetic medium due to dusting from the cleaning tape to be inspected is imaged to a proportion of a pixel in which powder adhering to the polishing tape for a magnetic medium due to dusting from the standard cleaning tape is imaged is less than 1.0.

7. The cleaning tape according to claim 3, wherein an average particle volume of the barium ferrite magnetic powder is 500 nm³ to 2000 nm³.

8. The cleaning tape according to claim 1, further comprising abrasive particles in the magnetic layer.

9. The cleaning tape according to claim 8, wherein the abrasive particles are alumina particles.

10. The cleaning tape according to claim 9, wherein an average particle size of the alumina particles is 20 nm to 80 nm.

11. The cleaning tape according to claim 1, wherein an electric resistance value of the surface of the magnetic layer of the cleaning tape is 1×10³ Ω/sq to 5×101 Ω/sq.

12. The cleaning tape according to claim 1, wherein the average thickness of the underlayer is 1.67 μm or more.

13. The cleaning tape according to claim 1, further comprising a magnetic layer, an underlayer, a base layer, and a back layer in this order.

14. The cleaning tape according to claim 1, wherein the average thickness (average total thickness) is 8.80 μm or more.

15. The cleaning tape according to claim 1, which is a cleaning tape for a magnetic recording system.
